(19) United States
(12) Patent Application Publication
(10) Pub. No.: US 2009/0142175 A1
(43) Pub. Date: Jun. 4, 2009

(54) Lifting Frame

(75) Inventors: Nathan John Woodcock, Lancashire (GB); Timothy Cunliffe, Lancashire (GB)

Correspondence Address: MARSHALL & MELHORN, LLC, FOUR SEAGATE - EIGHTH FLOOR, TOLEDO, OH, 43604, US

(73) Assignee: PILKINGTON GROUP LIMITED, ST. HELENS, MERSEYSIDE (GB)

(21) Appl. No.: 12/227,916

(22) PCT Filed: Jun. 1, 2007
(86) PCT No.: PCT/GB2007/050310

§ 371 Date: Dec. 2, 2008

(30) Foreign Application Priority Data
Jun. 6, 2006 (GB) 0611029.0

(51) Int. Cl. B65G 47/90; B65G 49/06

(52) U.S. Cl. 414/801; 414/618

(57) ABSTRACT

Lifting frames (2) suitable for moving a pack of sheet material (244) are described. Lifting frames according to the invention comprise first and second legs (4, 5), each leg having a foot (8,10) mounted thereon. The pack to be moved stands on the feet and is retained on the frame by pairs of fingers that can contact the front and rear faces of the pack. One pair of fingers (48,50) can be raised whilst another pair of fingers retains the pack on the frame. This enables the pack of sheet material to be removed from either side of the frame (2), thereby reversing the orientation of the pack in a single lifting operation. Methods of moving a pack of sheet material using lifting frames according to the invention are also described.

This invention concerns improvements in, or relating to, a lifting frame for carrying a pack of sheet material mounted upon one edge and positioned substantially vertically, and to methods of moving a pack of sheet material using such a lifting frame.

When flat glass is produced continuously, for example by a float or rolled process, a continuous ribbon of glass is formed and is annealed to remove stresses before being cut into sheets. The cut sheets are automatically stacked in a substantially vertical disposition by a robot onto an L-shaped holding frame known as a stillage. A stillage comprises a lower supporting base and a substantially vertical upright against which the sheets are stacked. The supporting base and upright are usually perpendicular to one another and the supporting base is usually inclined at an angle to the horizontal so that the front of the base is higher than the rear. The sheets lean against the upright at an angle of less than 10° to the vertical, typically between 3° and 7°. The width of the base is normally less than the width of the sheets so the sheets overhang the base on either side. When placed on the stillage the glass sheets are normally orientated in the same manner, that is with the top surface or bottom surface of each sheet facing forwards. With reference to sheets of glass produced by a float process, the bottom surface of a sheet refers to that surface which has been in contact with the tin in the float bath. The top surface of a sheet of float glass may have a coating deposited on it by an on-line coating process for example, by atmospheric pressure chemical vapour deposition in the float bath.

Glass sheets are stacked in packs and the number of sheets in a pack is usually limited to make it easier to subsequently transport the pack. Adjacent packs are separated from one another by means of spacers made from a suitable material, such as cardboard or polystyrene.

To transfer a pack of glass sheets to and from storage locations in a warehouse a lifting frame, often referred to as a “glass grab”, is used. The lifting frame usually comprises two vertical elongate members, or legs, connected at their upper ends by a horizontal cross member. Fixed to the lower end of the legs are support means, usually in the form of a pair of feet, on which the bottom edge of the pack rests. There are usually a pair of upper holding arms that latch over the top edge of the pack and behind the top of the back sheet to improve stability when the pack is being carried. The lifting frame can then be moved, for example by a crane hoist, to transport the pack of glass held thereon to a desired location for unloading. An example of such a lifting frame is described in EP0080264B1.

The pack is positioned on a second stillage, the upper holding arms are unlatched and the pack is released by moving the frame away from the stillage. The face of the pack which was facing forward when it was picked up by the frame is also facing forward when it is positioned on the second stillage and released from the frame.

There are occasions when it is necessary to reverse the orientation of the pack i.e. to position it upon a second stillage with the surface of the pack which was facing forward on the first stillage facing backwards on the second stillage. This type of operation may be needed if the sheets of glass have a coating on one surface or if a secondary processing operation is particularly suited, or not as the case may be, to a glass surface which has not been in contact with the tin bath. It is well known in the art that tin from the tin bath can diffuse into the bottom surface of the glass ribbon as the ribbon is being formed on the tin bath.

In order to reverse the orientation of the pack it must first be positioned upon a holding stillage. The frame is then moved around the pack and the glass is picked up from the other side. The pack is then moved to the desired location and positioned upon a second stillage with the face which was facing forward now facing backward. This takes much time and effort, and each time the pack of glass is moved there is an increased risk of glass breakage and injury to personnel.

Applicants have discovered that lifting frames can be constructed such that the orientation of a pack of sheet material can be reversed in a single lifting operation. The frame is constructed so as to allow the pack to be accommodated between the legs of the frame.

According to a first aspect the present invention provides a lifting frame adapted to carry a pack of sheet material mounted upon one edge in a substantially vertical disposition comprising an upper connecting means for attaching the frame to a means of lifting the frame; a first leg and a second leg; lower support means mounted on each leg for supporting the base of the pack; retaining means positioned to ensure that the pack is retained on the frame when it is moved and release means whereby the retaining means can be moved to a position which permits the pack to be removed from the frame, characterised in that the first leg and the second leg are sufficiently spaced to accommodate the major face of the pack between them. Preferably the retaining means can be moved to a position which permits the pack to be removed from either side of the frame.

The retaining means prevent the pack from toppling over and/or the base of the pack from slipping off the lower support means. Preferably at least one retaining means is located above the centre of gravity of the pack. More preferably at least one other retaining means is located below the centre of gravity of the pack.

Preferably at least one retaining means is mounted on each leg of the frame. The retaining means may be mounted on a support frame. The retaining means are able to contact one or both of the faces of the pack in the vicinity of an edge of that face.

In a preferred embodiment the first and second legs are mounted on a cross member, whereby the cross member does not obstruct the face of the pack when the pack is supported on the lower support means. Preferably the legs are mounted on the cross member by releasably securable means, so that the lifting frame can be used to carry a packs of different sizes. Preferably the distance between the legs may be varied, for example, one or both legs may be slidably mounted to the cross member. The cross member may also be telescopic. To enable the lifting frame to carry packs of a different height the distance between the cross member and the lower support means may be varied. Preferably the legs are substantially perpendicular to the cross member.

Preferably a retaining means is mounted on the cross member. Preferably that retaining means is mounted on a support frame.

The legs may be spaced a fixed distance apart. In this embodiment the retaining means are preferably switchable between a first position in which they extend sufficiently far into the space between the legs to contact the face or faces of the pack of glass and a second position in which they do not extend that far.

In order to allow packs of differing thicknesses to be lifted the frames may comprise a first retaining means which is able to contact one face of the pack and a second opposed retaining means which is able to contact the opposite face and means by which the distance between the pair of retaining means may be varied. The area of the lower support means may be varied. Suitably a secondary lower support means engages with one of the lower support means to provide an increased area that is able to support the base of the pack. Alternatively, the lower support means may be detachable and may be replaced by a lower support means having an increased area.

Normally the lower support means are fixed to the legs but in another embodiment the lower support means may be moved between a first position that is able to support the base of the pack when the frame is lifted, and a second position where the lower support means are not able to support the base of the pack when the frame is lifted. The lower support means may be releasably mounted, pivotably mounted or rotatably mounted. The lower support means may be mounted in such a way that the lifting frame is able to approach the pack either towards a major face or from above the pack. The lifting frame can then be positioned so that the pack is in between the legs and the lower support means may be rotated, pivoted or attached into position so that the lower support means are lower than the bottom edge of the pack. The lifting frame may then be raised, so that the lower support means is moved into contact with bottom edge of the pack and the pack may be lifted.

The lower support means may be secured to each leg. They may be releasably secured to the leg. The lower support means may be moved between a first position to support one pack and a second position to support one or more packs.

The first leg and second leg preferably lie in the same plane.

Suitably lifting frames according to the present invention may be inclined at an angle to the vertical of less than 20°, preferably less than 10° when the lifting frame is connected to the moving means. When the pack is supported on the lower support means and the lifting frame is lifted, the lifting frame may be hanging from the connecting means such that the pack is substantially vertical.

Usually the pack of sheet material will consist of one or more substantially identical sheets stacked in a substantially vertical disposition with adjacent faces in contact. Each sheet has a thickness Tₛ. Typically the number of sheets in a pack is such that the thickness of the pack Tₚ, is less than the length or the width of the major face of a sheet. When Tₚ is much less than the length or width of the major face of the pack, for example when Tₚ is less than half the width or half the length of the major face of the pack, and the pack is stacked substantially vertically, the pack is relatively unstable and liable to topple over unless supported, especially when being carried.

The faces of a pack may be protected by a sheet of a suitable material. The outermost sheets of a pack may or may not have the same dimensions as the other sheets in the pack.

Usually a number of packs of sheet material are stacked together, with a space between adjacent packs created by spacers made from a suitable material such as cardboard or polystyrene. Suitably the means of retaining the pack on the lower support means is able to fit in the space between adjacent packs. The pack is normally supported on a stand that raises the base of the pack from the floor.

From a second aspect this invention provides a method of moving a pack of sheet material positioned substantially vertically using a lifting frame as hereinbefore described which comprises the steps of positioning the pack between the first leg and the second leg supported at its lower edge by the lower support means, positioning at least one retaining means so as to retain the pack on the support means, moving the frame to a desired position and operating the release means so as to allow the pack to be removed from the frame. Preferably the pack may be removed from either side of the frame.

In order that the invention may be better understood, it will now be described, by way of example, with reference to the accompanying drawings, in which all common components have a common label and in which:

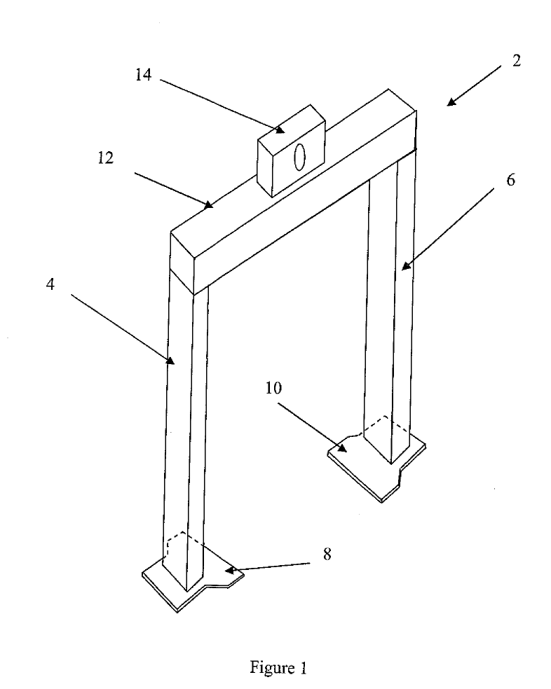

FIG. 1 is a perspective view of a lifting frame according to the present invention without a retaining means to retain the pack on the lower support means;

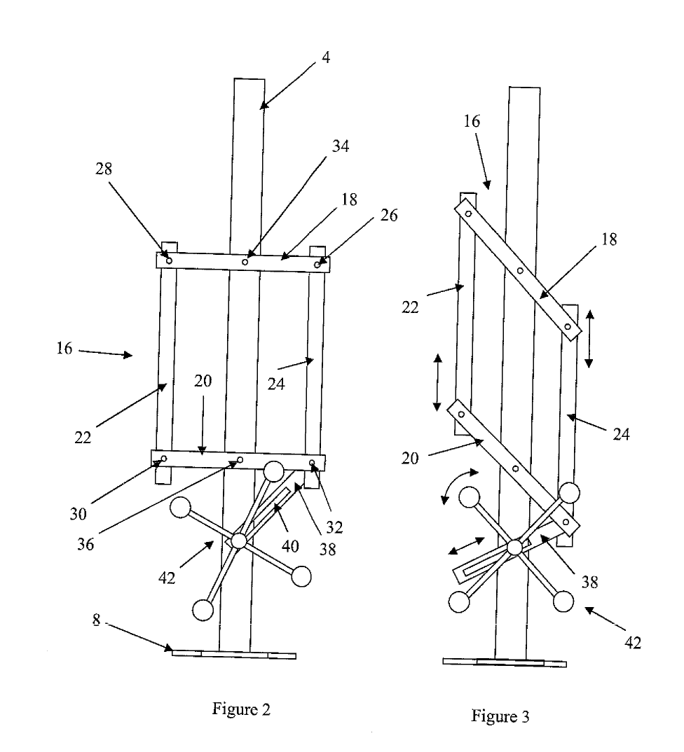

FIG. 2 is a side view of a lifting frame that has a support frame in the fully open position mounted on a leg;

FIG. 3 is a side view of a lifting frame that has a support frame that has been partially closed and is mounted in on a leg;

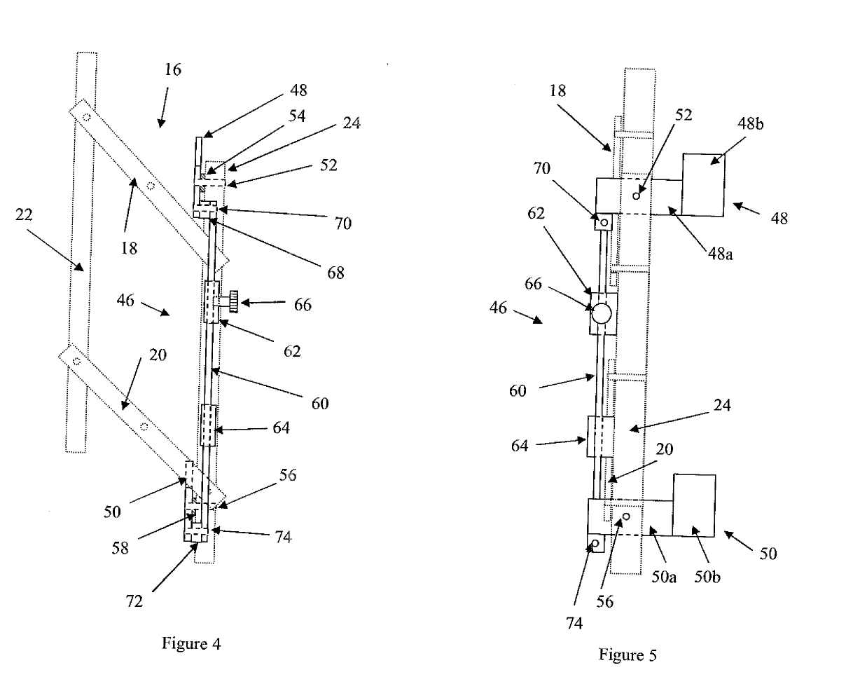

FIG. 4 is a front elevation of the support frame shown in FIG. 3 that has retaining means mounted thereon wherein the retaining means are in position to contact a major surface of a pack;

FIG. 5 is a side elevation of the support frame shown in FIG. 3 that has retaining means mounted thereon wherein the retaining means are in position to contact a major surface of a pack;

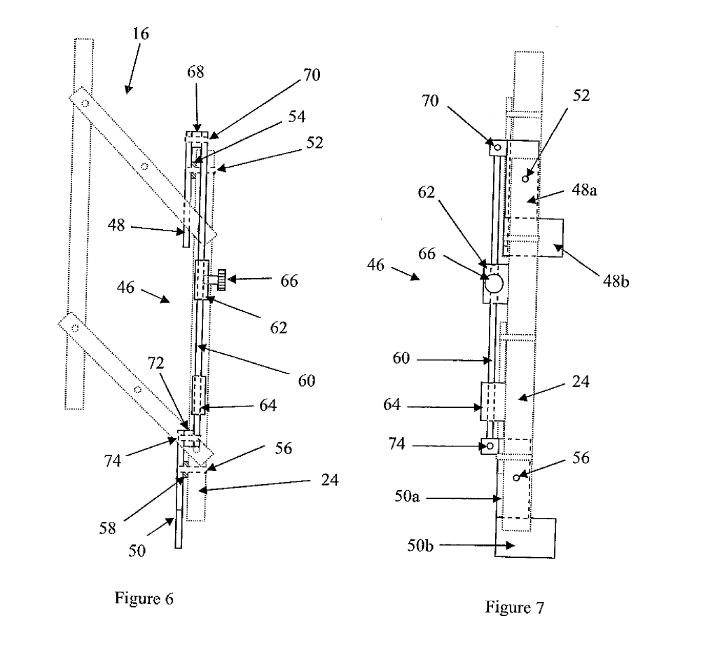

FIG. 6 is a front elevation of the support frame shown in FIG. 3 that has retaining means mounted thereon wherein the retaining means are in position that does not contact a major surface of a pack;

FIG. 7 is a side elevation of the support frame shown in FIG. 3 that has retaining means mounted thereon wherein the retaining means are in position that does not contact a major surface of a pack;

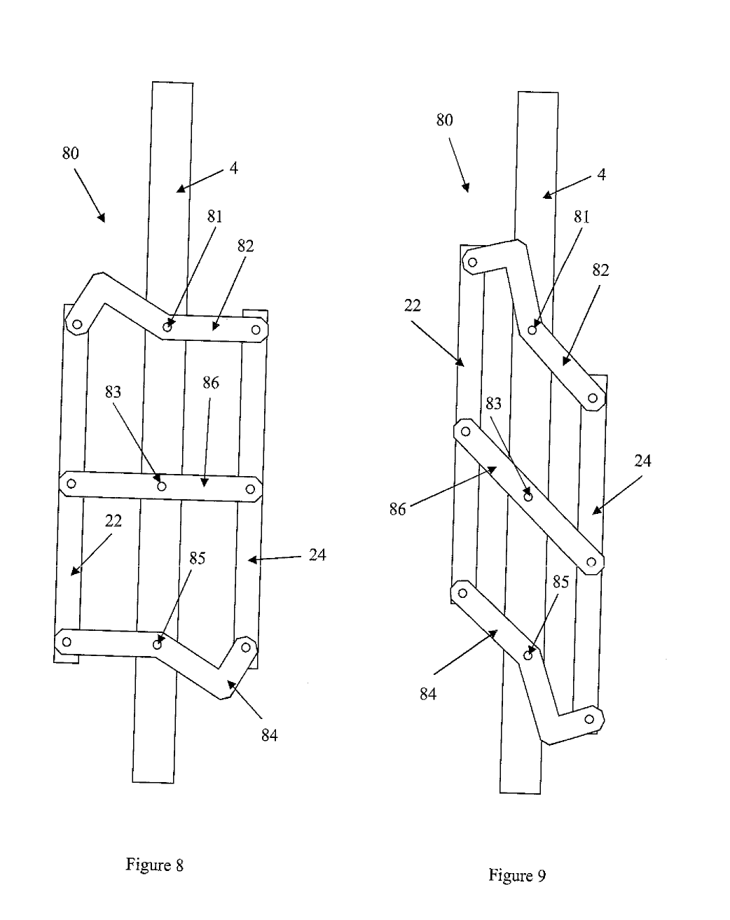

FIG. 8 is a front elevation of an alternative support frame in the fully open position mounted on a leg of a lifting frame;

FIG. 9 is a front elevation of the support frame shown in FIG. 8 in the partially closed position;

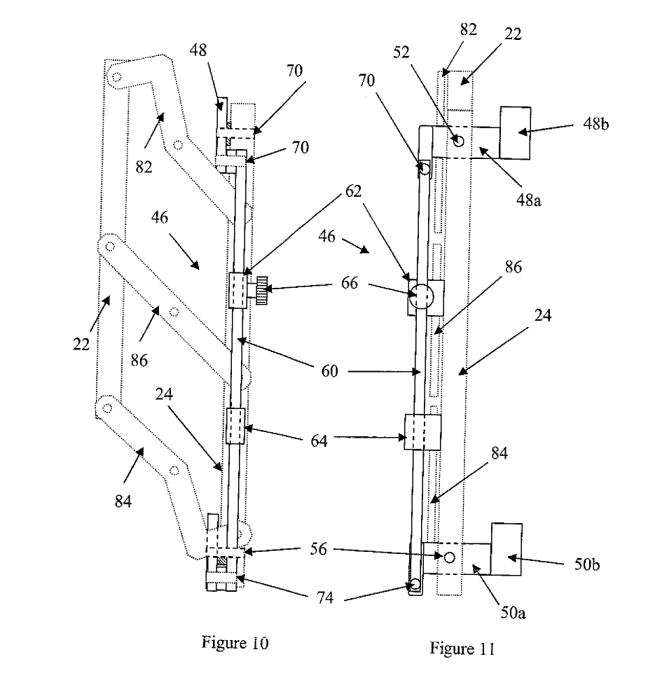

FIG. 10 is a front elevation of the support frame shown in FIG. 8 with a retaining means mounted thereon;

FIG. 11 is a side elevation of the support frame shown in FIG. 8 with a retaining means mounted thereon;

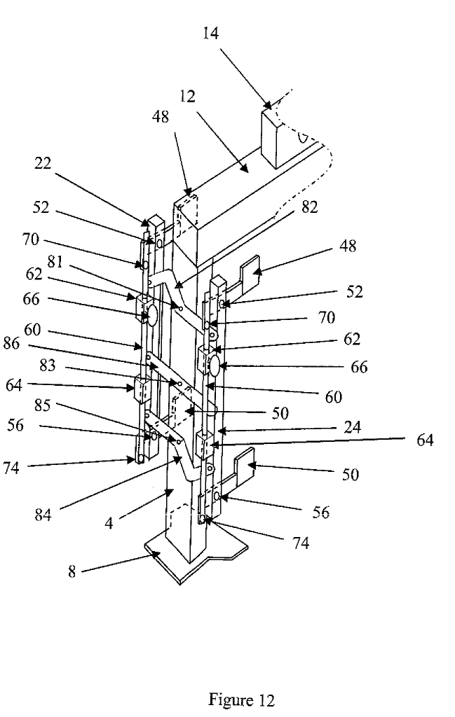

FIG. 12 is a perspective view of a portion of a lifting frame incorporating the support frame shown in FIGS. 10 and 11;

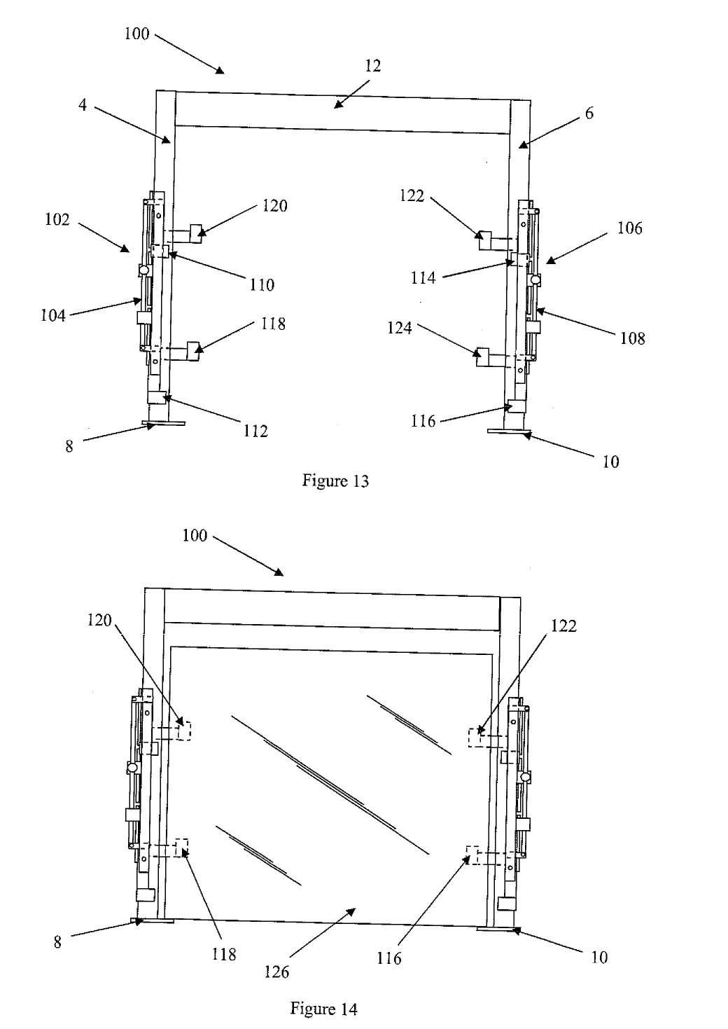

FIG. 13 is a front elevation of a lifting frame showing the retaining means in position to contact the rear face of a pack of sheet material;

FIG. 14 is a front elevation of the lifting frame of FIG. 13 with a pack of sheet material in between the legs;

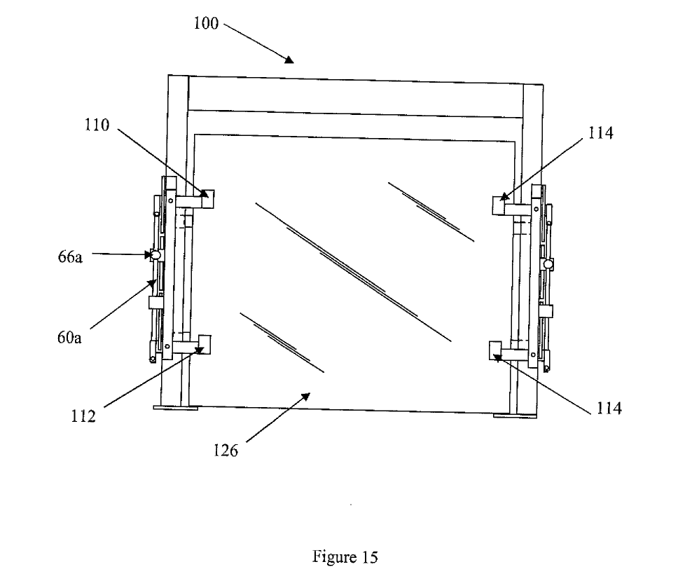

FIG. 15 is a front elevation of the lifting frame of FIG. 13 with a pack of sheet material in position ready to be lifted and stabilised both on the front and rear faces;

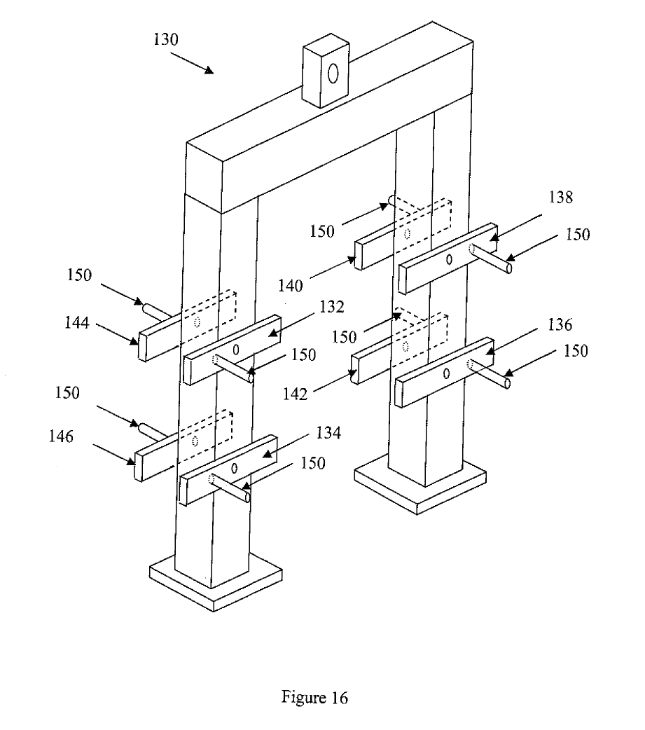

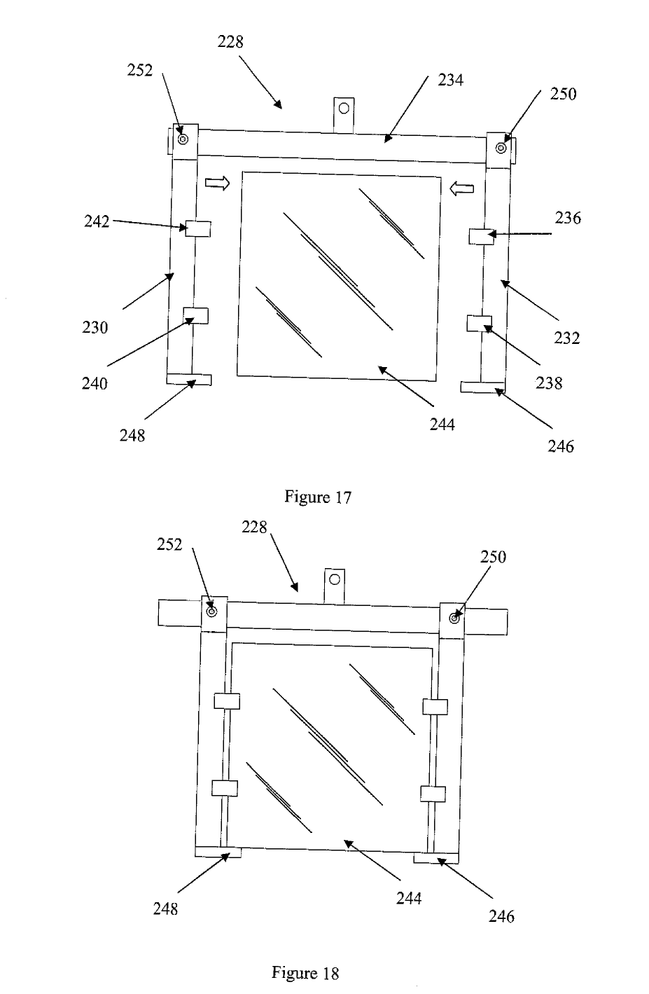

FIG. 16 is a perspective view of a lifting frame that has retaining means mounted directly on each leg;

FIG. 17 is a schematic front elevation of another embodiment of a lifting frame according to the invention where the legs are movably mounted to a cross member;

FIG. 18 is a schematic front elevation of the lifting frame of FIG. 17 wherein the pack of sheet material is ready to be lifted; and

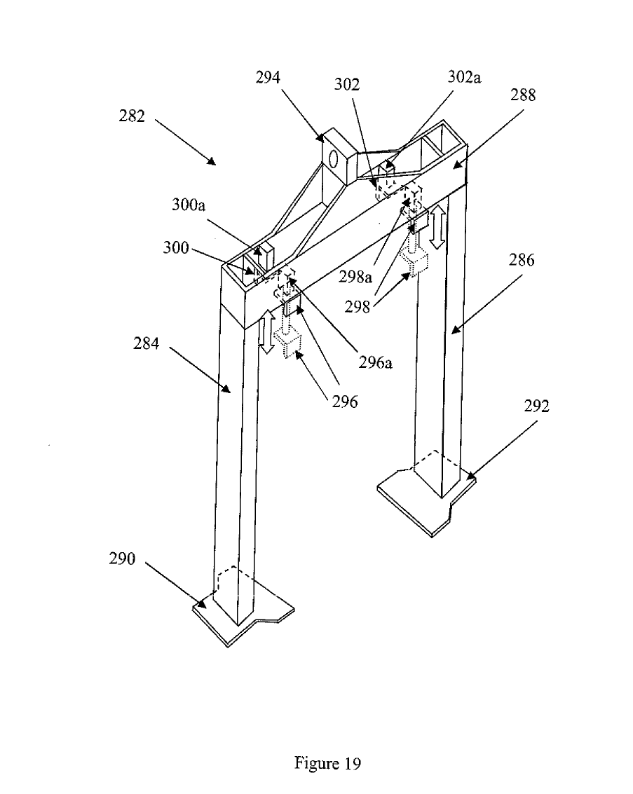

FIG. 19 is a perspective view of another embodiment of the invention wherein the retaining means are mounted on the cross member above the major face of the pack.

FIG. 1 shows a lifting frame 2 made from steel that has a first vertical leg 4 and a second vertical leg 6. For clarity, the lifting frame is shown without a retaining means to retain the pack on the feet. Mounted on the end of the first leg 4 is a first foot 8 and mounted on the end of the second leg 6 is a second foot 10. The feet 8 and 10 are releasably mounted to the legs 4 and 6. The feet are secured in position by means of bolts (not shown). The first and second legs 4 and 6 are connected by a horizontal cross member 12. The first and second legs 4 and 6 are fixed to cross member 12. The legs 4 and 6 are sufficiently spaced such that the major face of the pack can be accommodated between them. Connected to the cross member 12 is a lifting chassis 14 designed to be connected to a crane or hoist (not shown). The crane or hoist is used to move the lifting frame between locations.

FIG. 2 shows a side view of a lifting frame wherein a support frame 16 made from steel is mounted on each leg 4 and 6. The support frame 16 is made of two parallel cross members 18 and 20 and two parallel vertical members 22 and 24. All four members are connected by rivets 26, 28, 30 and 32. The support frame is mounted to the leg 4 by means of rivets 34 and 36. The support frame can rotate about the rivets 34 and 36 so that the separation of the vertical members 22 and 24 can be varied. An adjusting link 38 is connected at one end to cross member 20 and vertical member 24 and at the other end to the leg 4. A screw (not shown) is mounted to the leg 4 and passes through the slot 40 in the adjusting link 38. The spider 42 has a central threaded portion that fits over the screw and when tightened holds the adjusting link 38 in position. To vary the separation of the vertical members 22 and 24 the spider is undone and the adjusting link slid downwards so that the desired separation is reached.

FIG. 3 shows the support frame of FIG. 2 wherein the separation of the two vertical members 22 and 24 has been reduced by undoing the spider 42, sliding the adjusting link 38 downwards and then tightening back up the spider.

FIG. 4 shows a front elevation of the support frame 16 and a retaining means 46. For clarity, only one of the vertical members 24 has been shown with a retaining means 46, although an identical arrangement is mounted on vertical member 22. An identical support frame 16 is also mounted on leg 6, not shown. The retaining means comprise an upper finger 48 and a lower finger 50. The upper finger 48 is mounted on the vertical member 24 by a setscrew (not shown) passing through bore 52 and spaced from the vertical member 24 by spacer 54. The lower finger 50 is mounted on the vertical member 24 by a setscrew (not shown) passing through bore 56 and spaced from the vertical member 24 by spacer 58. Actuating means 46 comprises a metal rod 60 that is connected to both the upper finger 48 and the lower finger 50. The metal rod 60 is connected to the vertical member 24 via rod supports 62 and 64. The metal rod 60 passes through a bore in each of the rod supports 62 and 64 and is held in position by a thumbscrew 66 which passes through the rod support 62. The upper finger 48 is connected to one end of the rod 60 by a setscrew passing through bore 70 via a spacer 68. The lower finger 50 is connected to the other end of the rod 60 by a setscrew passing through bore 74 via a spacer 72. Moving the rod 60 up or down actuates the retaining means 48 and 50.

FIG. 5 shows a side elevation of the support frame 16 and retaining means 46. This figure shows the rod supports 62 and 64 are fixed to the vertical member 24. Each finger 48 and 50 comprises a rectangular body portion 48a and 50a and an end portion 48b and 50b that is designed to contact a face of the pack when the finger is in the “down” position as shown. The upper finger 48 and lower finger 50 are connected by the rod 60. By releasing the thumbscrew 66 the rod can slide through the rod supports 62 and 64 and the upper and lower fingers move at the same time.

FIG. 6 shows a front elevation of the support frame 16 with retaining means 46 where the rod 60 has been moved upwards so that the upper and lower fingers 48 and 50 have been moved to a position wherein they are not able to contact a major face of a pack when said pack is in between the legs 4 and 6. FIG. 7 shows a side elevation of FIG. 6.

FIG. 8 shows a front elevation of a second type of support frame 80 mounted to one leg 4 of a lifting frame by screws 81, 83 and 85. An identical support frame 80 could be mounted to the other leg 6. The support frame 80 has a first cranked side finger 82 and a second cranked side finger 84. A side finger link 86 connects the two vertical members 22 and 24. In this figure the support frame is in the fully open position. Retaining means, for example fingers, may be attached to vertical members 22 and 24.

FIG. 9 shows a front elevation of the support frame 80 shown in FIG. 8 in the partially closed position. An adjusting linkage arrangement and spider as used in FIGS. 2 and 3 could be used to open and close the supporting frame 80.

FIGS. 10 and 11 show the support frame 80 with a retaining means 46 mounted on one vertical member 24. The actual support lifting frame has a retaining means arrangement 46 mounted on the other vertical member 22. Although not shown, both legs of the lifting frame have a supporting frame 80 with a retaining means 46 mounted on each vertical member of each support frame.

For clarity, FIG. 12 shows in perspective only a portion of a lifting frame according to the present invention. The lifting frame is as shown in FIG. 1 and has support frame 80 and retaining means 46 as described in FIGS. 10 and 11. The figure shows a support frame connected to the first leg 4 by means of screws 81, 83, 85. The upper finger 48 and the lower finger 50 are in the “down” position.

FIG. 13 shows a front elevation of a lifting frame according to the invention. The lifting frame 100 has two vertical legs 4 and 6 connected by cross member 12. At the end of leg 4 is foot 8 and at the end of leg 6 is foot 10. The lifting frame 100 has a left support frame 102 mounted on the leg 4 and a right support frame 106 mounted to leg 6. The support frames 102 and 106 are of the type shown in FIGS. 8 and 9. Mounted on the left support frame 102 is a front left actuating means 104 which links the front upper left retaining means 110 and the front lower left retaining means 112. Mounted on the right support frame 106 is a front right actuating means 108 which links the front upper right retaining means 114 and front lower right retaining means 116. The retaining means 110, 112, 114, 116 are all in the “down” position and are able to contact the front face of a pack of sheet material positioned in between the legs 4 and 6 and supported on feet 8 and 10. There are equivalent retaining means associated with the rear of the lifting frame. The retaining means 118, 120, 122 and 124 are all in the “down” position. The retaining means can stabilise the pack when the frame is lifted and can prevent the pack from sliding off the feet.

FIG. 14 shows the lifting frame of FIG. 13 with a pack of sheet material 126 in between the legs 4 and 6. The retaining means 118, 120, 122 and 124 contact the rear face of the pack 26 to prevent the pack from toppling when the lifting frame is raised and to prevent the pack from sliding off the feet. The legs 4 and 6 are sufficiently spaced to accommodate the major face of the pack 126 between them.

FIG. 15 shows the lifting frame of FIG. 13 wherein the retaining means 110, 112, 114 and 116 have been moved into the “down” position. The left retaining means are moved into the down position by releasing screw 66a and sliding rod 60a upwards. The right retaining means are moved into the down position by releasing screw 66b and sliding rod 60b upwards. Rods 60a and 60b can be fixed into position by tightening screws 66a and 66b respectively. For clarity, the rear retaining means shown in FIGS. 13 and 14 are not shown in FIG. 15.

FIG. 16 shows a perspective view of an embodiment of the invention 130 wherein the retaining means are mounted directly to the legs. The figure shows the following retaining means; the front upper left 132, the front lower left 134, the front lower right 136, the front upper right 138, the rear upper right 140, the rear lower right 142, the rear upper left 144 and the rear lower left 146. Each retaining means is fixed directly to the leg of the lifting frame by a screw 148. The retaining means can rotate about screw 148. Mounted on each retaining means is a handle 150 to move the retaining means between the “down” position as shown, wherein the retaining means is able to contact the front or rear major surface of the pack when it is supported on the feet 8 and 10, and the “up” position wherein the retaining means are not able to contact a major surface of the pack. Each retaining means can be actuated individually. Each stabilising means can be held in the up or down position by a bolt passing through the retaining means and extending into the leg (not shown). With this particular embodiment the width of pack that can be stabilised by the stabilising means cannot exceed the separation of the front 132, 134, 136 and 138 and rear 140, 142, 144 and 146 retaining means.

FIG. 17 shows an embodiment of the invention 228 wherein the legs 230 and 232 are slidably mounted on a cross member 234. In this embodiment the retaining means 236, 238, 240 and 242 do not need to be moveable between and “up” and “down” position. A pack of glass sheets 244 is stacked on a stillage (not shown). The lifting frame 228 is moved into position so that the pack is in between the two legs 228 and 232. The legs 228, 230 can be slid in the direction shown by the arrows so that the lower feet 246 and 248 are beneath the base of the pack.

In FIG. 18 the lifting frame of FIG. 17 has been moved into a position to lift the pack of glass sheets 244. The legs have been moved such that the pack of glass sheets is supported on the feet 246 and 248 and the legs are sufficiently spaced such that the major face of the pack can be accommodated between them. The legs 230 and 232 can be secured to the cross member 234 using bolts 250 and 252. The lifting frame can then be raised and the pack is retained on the feet by the retaining means 236, 238, 240 and 242. The lifting frame can be moved to another stillage where the frame can be lowered so that the pack is supported on the second stillage. The legs can be released by undoing bolts 250 and 252, slid away from the sides of the pack and the frame lifted away.

FIG. 19 shows another embodiment of the invention. The lifting frame 282 has two vertical legs 284 and 286 connected at the top by a cross member 288. At the end of leg 284 is foot 290 and at the end of leg 286 is foot 292. The legs 284 and 286 are sufficiently spaced such that the major face of a pack of sheet material can fit between them. The cross member has a lifting chassis 294 so that the lifting frame may be connected to a crane or hoist. Associated with the cross member 288 are retaining means 296, 298, 300 and 302. Each of the retaining means 296, 298, 300 and 302 can move in a vertical direction, as shown in the case of stabilising means 296 and 298 by the dotted lines. The retaining means are driven by linear motors 296a, 298a, 300a and 302a. The linear motors are fixed to the cross member 288. Each linear motor may be driven independently.

### COMPARATIVE EXAMPLE

A conventional lifting frame of the type described in EP0080264B1 was used to lift a pack of glass sheets from a first stillage to a second stillage so that the orientation of the pack had been reversed when placed on the second stillage.

The pack of glass sheets had a front face and a rear face. The pack was to be reversed so that the front face faces the upright of the second stillage. The conventional lifting frame approaches the pack in the direction of the front face.

When the lifting frame is in position to support the pack of glass sheets, the lifting frame obstructs the front face of the pack. When the pack is supported on the feet, the lifting frame is moved to a temporary holding frame. The temporary holding frame consists of a base and two vertical uprights. Mounted on each upright is a front and rear finger support. When the lifting frame is moved so that the pack is in between the two uprights, the front and rear fingers can be moved into position to support the pack in a vertical position.

Once supported by the temporary holding frame, the lifting frame can be moved to the other side of the pack. The lifting frame can be moved towards the rear face of the pack and moved into position ready to lift the pack. When the pack is supported on the lifting frame, the front and rear fingers on the temporary holding frame can be moved out of position. The pack can then be moved using the lifting frame towards the second stillage.

The pack may then be supported by the second stillage so that the lifting frame can be moved away from the pack. The orientation of the pack has been reversed, that is, the face that was originally facing away the stillage upright is now facing towards the stillage upright.

### Example 1

A number of packs of sheets of coated glass were stacked on a stillage with the coated faces facing towards the stillage upright. The base of the stillage was not as wide as the major face of the packs, so that each pack overhangs the base of the stillage. The packs are raised from the floor. A lifting frame of the type shown in FIG. 12 was used to rotate a pack 180° about a vertical axis, that is, to move to pack to another stillage such that the uncoated side of the glass sheets faced the stillage upright.

The lifting frame used had a first leg and a second leg. Connected to the bottom of the first leg was a first foot and connected to the bottom of the second leg was a second foot. The two legs were connected at the top by a cross member. A lifting chassis was connected to the cross member to allow the lifting frame to be moved by a crane. Mounted to the first leg was a front right retaining means initially in the “up” position and rear right retaining means initially in the “down” position. Mounted to the second leg was a front left retaining means initially in the “up” position and a rear left retaining means initially in the “down” position. The front retaining means were in the “up” position so they did not obstruct the front face of the pack when the lifting frame was moved so that the pack was between the legs and the feet were lower than the base of the pack. The rear retaining means were in the “down” position so that they were able to contact the front face of the pack when the pack was in between the first and second legs.

The lifting frame is moved into position in a direction perpendicular to the front face of the pack. Typically the packs were inclined at an angle to the vertical of less than 10°. When the pack was positioned in between the legs and the feet were beneath the base of the pack, the rear retaining means were moved into the “down” position so that they were able to contact the rear face of the pack. The lifting frame was then raised so that the two lower feet contact the base of the pack and the pack is lifted. Because the pack was inclined at an angle to the vertical, initially the pack is supported on the rear retaining means as the frame was lifted. When the weight of the pack was supported on the feet, the lifting frame was hanging substantially vertically and the retaining means were able to contact the faces of the pack and retain the pack on the feet.

The lifting frame was then be moved to a second stillage and moved so that the uncoated faces of the sheets in the pack face the upright of the second stillage. The second stillage was directly opposite the first stillage. The lifting frame may have been rotated if the second stillage had been adjacent to the first stillage.

The lifting frame was moved so that the bottom of the pack was above the base of the second stillage and the lifting frame lowered so that the bottom of the pack contacts the base of the stillage. The base of the second stillage was inclined, such that when the pack was stacked on the stillage it was inclined at an angle of less than 10° to the vertical. When the lifting frame was lowered so that the base of the pack contacted the base of the second stillage, the pack was temporarily supported by the front retaining means. When the pack was supported on the second stillage, by leaning against the upright of the second stillage, the front retaining means were be moved into the “up” position and the lifting frame was moved away from the pack in a direction perpendicular to the rear face of the pack. The orientation of the pack had been reversed so that the front face was now facing the upright of the second stillage and the rear face was now the uppermost face in the pack.

The lifting frame shown in FIG. 12 has been used to lift and reverse the orientation of packs of float glass with the dimensions given in table 1. For each given pack A-N, all the sheets in each pack were the same.

TABLE 1

| | Sheet | Sheet | Sheet | Number | Total Pack | Weight of Pack (kg), |
|---|---|---|---|---|---|---|
| | Thickness | width | height | of Sheets | Thickness | assuming float glass density |
| Pack | mm | mm | mm | in Pack | mm | is 2500 kg/m³ |
| A | 3 | 3210 | 2250 | 35 | 105 | 1896 |
| B | 4 | 3210 | 2550 | 28 | 112 | 2292 |
| C | 4 | 3210 | 2400 | 26 | 104 | 2003 |
| D | 4 | 3210 | 2250 | 37 | 148 | 2672 |
| E | 4 | 3210 | 2250 | 36 | 144 | 2600 |
| F | 4 | 3210 | 2250 | 28 | 112 | 2022 |
| G | 4 | 3210 | 2100 | 22 | 88 | 1483 |
| H | 4 | 3210 | 2100 | 30 | 120 | 2022 |
| I | 4 | 3210 | 2100 | 40 | 160 | 2696 |
| J | 6 | 3210 | 2250 | 25 | 150 | 2708 |
| K | 6 | 3210 | 2100 | 26 | 156 | 2629 |
| L | 4 | 3210 | 2250 | 40 | 160 | 2889 |
| M | 6 | 3210 | 2250 | 26 | 156 | 2817 |
| N | 8 | 3210 | 2250 | 20 | 160 | 2889 |

Packs of glass with a major face of 6×3.2 m have been lifted using a lifting frame according to the invention. The packs were in either landscape or portrait orientation.

1-22. (canceled)

23. A lifting frame adapted to carry a pack of sheet material mounted upon one edge in substantially vertical disposition comprising means for attaching said frame to a means of lifting the frame; a first leg and a second leg; lower support means mounted on each leg for supporting the base of the pack; retaining means positioned so as to ensure the pack is retained on the frame when it is moved and release means whereby the retaining means are moved to a position which permits the pack to be removed from the frame, wherein the first leg and the second leg are sufficiently spaced to accommodate the major face of the pack between them.

24. The lifting frame according to claim 23, wherein the pack may be removed from either side of the frame.

25. The lifting frame according to claim 23, wherein at least one retaining means is mounted on each leg.

26. The lifting frame according to claim 25, wherein the retaining means are mounted on a support frame.

27. The lifting frame according to claim 23, wherein the first and second legs are mounted on a cross member.

28. The lifting frame according to claim 27, wherein the first leg and second legs are fixed to the cross member.

29. The lifting frame according to claim 27, wherein retaining means are mounted on the cross member.

30. The lifting frame according to claim 29, wherein the retaining means are mounted on a support frame.

31. The lifting frame according to claim 23, wherein the retaining means are able to contact one or both of the faces of the pack.

32. The lifting frame according to claim 31, wherein the retaining means are able to contact the faces in the vicinity of the edges of the faces.

33. The lifting frame according to claim 23, wherein the release means operate so as to switch the retaining means between a first position and a second position such that the pack may be removed from either side of the frame.

34. The lifting frame according to claim 33, wherein the legs are spaced a fixed distance apart.

35. The lifting frame according to claim 23 which comprises at least one pair of opposed retaining means which are able to contact opposed faces of the pack.

36. The lifting frame according to claim 23, wherein the retaining means takes the form of a finger.

37. The lifting frame according to claim 23, wherein at least one retaining means is located above the center of gravity of the pack.

38. The lifting frame according to claim 23, wherein the first leg and second leg are coplanar.

39. The lifting frame according to claim 23, wherein the legs are perpendicular to the cross member.

40. A method of moving a pack of sheet material positioned substantially vertically, using a lifting frame according to claim 23, comprising positioning the pack between the first leg and the second leg and supported on the lower support means, positioning at least one retaining means so as to retain the pack, lifting and moving the frame to a desired position and operating the release means so as to allow the pack to be removed from the frame.

41. The method according to claim 40, wherein the pack is removed from either side of the frame.

42. The method of moving a pack of sheet material according to claim 40, wherein the thickness of an individual sheet in the pack is between 1 and 25 mm.

43. The method of moving a pack of sheet material according to claim 42, wherein the pack is a pack of glass sheets and thickness of each sheet in the pack is between 1 and 6 mm.
